(19) United States
(12) Patent Application Publication
(10) Pub. No.: US 2009/0325489 A1
(43) Pub. Date: Dec. 31, 2009

(54) WIRELESS COMMUNICATION APPARATUS, CONTROL METHOD THEREFOR, AND STORAGE MEDIUM STORING CONTROL PROGRAM THEREFOR

(75) Inventor: Hideo Kawahara, Hatogaya-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/493,465

(22) Filed: Jun. 29, 2009

(30) Foreign Application Priority Data
Jun. 30, 2008 (JP) 2008-170751

(51) Int. Cl. H04L 9/32; H04B 7/005; G06F 21/00

(52) U.S. Cl. 455/41.2; 726/7

(57) ABSTRACT

An authentication unit authenticates an external apparatus if the external apparatus is registered beforehand as an apparatus that permits data transmission to a wireless communication apparatus. An instruction unit instructs transmission of data stored in the wireless communication apparatus. A determination unit determines whether data transmission is instructed by the instruction unit if the wireless communication apparatus and the external apparatus are close within the communication available range. A control unit transmits data to the external apparatus after authentication of the external apparatus by the authentication unit if the determination unit determines that the data transmission has not been instructed, and transmits data to the external apparatus without authentication by the authentication unit if the determination unit determines that the data transmission has been instructed by the instruction unit.

### BACKGROUND OF THE INVENTION

1. Field of the Invention

The present invention relates to a wireless communication apparatus that performs close proximity wireless communication in a predetermined communication available range, a control method therefor, and a storage medium storing a control program therefor.

2. Description of the Related Art

In recent years, a wireless system using close proximity wireless communication that allow communication within a range of several centimeters through several tens of centimeters using induction electric field, which is generated by the passage of high frequency current through a conductor, etc. has been developed. Close proximity wireless communication feature to have a high-speed data transmission rate and to have little influence on other wireless system due to an exclusive use for a point-blank range. Close proximity wireless communication is suitable for the data communication that is free from cable connections among apparatuses.

For example, a technique to transmit data stored in a card to a communication target apparatus by wireless communication when the card with an internal antenna is brought close to the communication target apparatus is known (for example, see Japanese laid-open patent publication (Kokai) No. H07-141537 (JP07-141537A)). At present, a technique to perform data communication between a communication terminal, which is not only a card with an internal antenna but also a cellular phone or the like, and another apparatus when the communication terminal is brought close to the other apparatus is also known.

Although the close proximity wireless communication is convenient, data is transmitted between the apparatus concerned and another apparatus under a user's unintentional condition because the data communication is performed when the apparatus concerned is brought close to the other apparatus. Thus, a method to restrict data communication between a communication-permitted apparatus and a no-registered apparatus by registering apparatuses that permit data transmission beforehand is also considered.

However, the conventional method to register apparatuses that permit data transmission beforehand as mentioned above has a problem that an operation to register the apparatuses that permit data transmission beforehand is complicated to a user. For example, when a user tries to perform data communication between an unregistered apparatus that is owned by a person who meets the first time and a user's own apparatus on the spot, it is complicated because the user has to perform an operation for registering the unregistered apparatus used as a communication partner.

### SUMMARY OF THE INVENTION

The present invention provides a wireless communication apparatus, a control method therefor, and a storage medium storing a control program therefor that are capable of transmitting data between apparatuses without complicated operations while preventing unintentional data transmission to an external apparatus.

Accordingly, a first aspect of the present invention provides a wireless communication apparatus that performs close proximity wireless communication with an external apparatus if approaching to the external apparatus within a predetermined distance, the wireless communication apparatus comprising an authentication unit adapted to authenticate the external apparatus if the external apparatus is registered beforehand as an apparatus that permits data transmission to the wireless communication apparatus, an instruction unit adapted to instruct transmission of data stored in the wireless communication apparatus, a determination unit adapted to determine whether data transmission is instructed by the instruction unit if the wireless communication apparatus and the external apparatus are close within the communication available range, and a control unit adapted to transmit data to the external apparatus after authentication of the external apparatus by the authentication unit if the determination unit determines that the data transmission has not been instructed, and to transmit data to the external apparatus without authentication by the authentication unit if the determination unit determines that the data transmission has been instructed by the instruction unit.

Accordingly, a second aspect of the present invention provides a control method for a wireless communication apparatus that performs close proximity wireless communication with an external apparatus if approaching to the external apparatus within a predetermined distance, the control method comprising, authenticating the external apparatus if the external apparatus is registered beforehand as an apparatus that permits data transmission to the wireless communication apparatus, instructing transmission of data stored in the wireless communication apparatus, determining whether data transmission is instructed if the wireless communication apparatus and the external apparatus are close within the communication available range, transmitting data to the external apparatus after authentication of the external apparatus if it is determined that the data transmission has not been instructed, and transmitting data to the external apparatus without authentication if it is determined that the data transmission has been instructed.

The features and advantages of the invention will become more apparent from the following detailed description taken in conjunction with the accompanying drawings.

### BRIEF DESCRIPTION OF DRAWINGS

FIG. 1 is a block diagram showing a configuration of a close proximity wireless communication apparatus on a sender side and a close proximity wireless communication apparatus on a receiver side according to a first embodiment of the present invention.

FIG. 2 is a flowchart showing a wireless communication process in the close proximity wireless communication apparatus on the sender side when communicating with the close proximity wireless communication apparatus on the receiver side according to the first embodiment.

FIG. 3 is a block diagram showing a configuration of a close proximity wireless communication apparatus on a sender side and a close proximity wireless communication apparatus on a receiver side according to a second embodiment of the present invention.

FIG. 4 is a flowchart showing a wireless communication process in the close proximity wireless communication apparatus on the sender side when communicating with the close proximity wireless communication apparatus on the receiver side according to the second embodiment.

FIG. 5 is a flowchart showing a wireless communication process in the close proximity wireless communication apparatus on the sender side when communicating with the close proximity wireless communication apparatus on the receiver side according to a third embodiment of the present invention.

FIG. 6 is a flowchart showing a wireless communication process in the close proximity wireless communication apparatus on the sender side and the close proximity wireless communication apparatus on the receiver side according to a fourth embodiment of the present invention.

FIG. 7 is a block diagram showing a configuration of a close proximity wireless communication apparatus on a sender side and a close proximity wireless communication apparatus on a receiver side according to a fifth embodiment of the present invention.

FIG. 8 is a flowchart showing a wireless communication process in the close proximity wireless communication apparatus on the sender side and the close proximity wireless communication apparatus on the receiver side according to the fifth embodiment.

### DESCRIPTION OF THE PREFERRED EMBODIMENTS

Hereafter, embodiments according to the present invention will be described in detail with reference to the drawings.

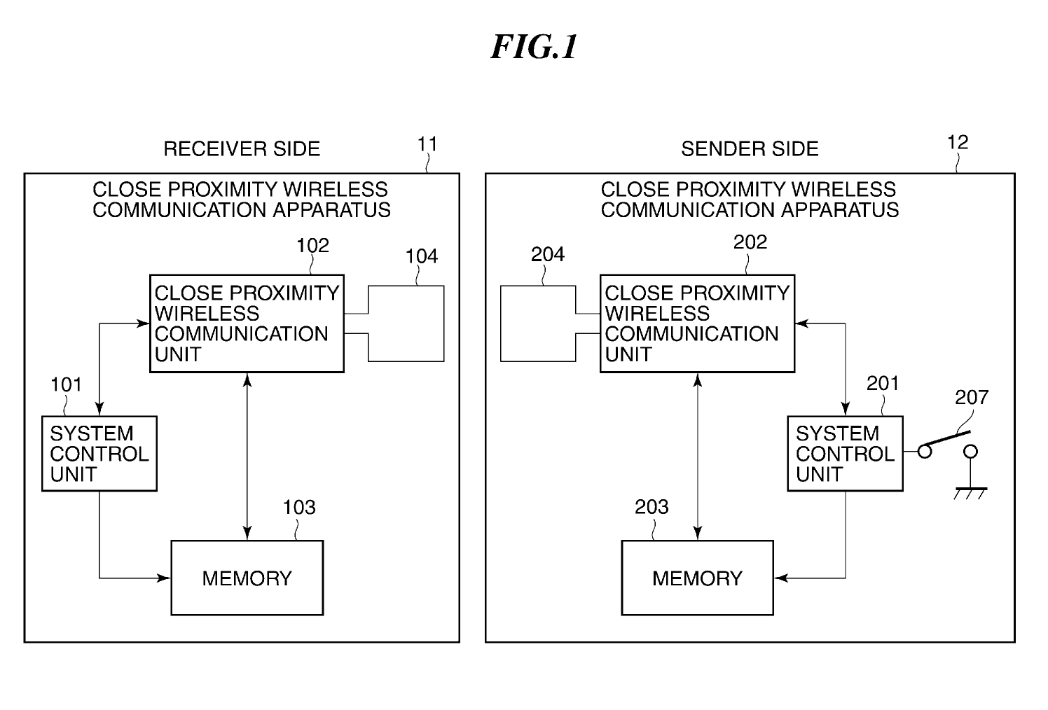

FIG. 1 is a block diagram showing a configuration of a close proximity wireless communication apparatus on a sender side and a close proximity wireless communication apparatus on a receiver side according to a first embodiment of the present invention. It should be noted that the configuration shown in FIG. 1 is an example for embodying an authentication unit, an instruction unit, a determination unit, a control unit, and a display unit of the present invention.

In FIG. 1, the close proximity wireless communication apparatus 11 on the receiver side is provided with a system control unit 101, a close proximity wireless communication unit 102, a memory 103, and a radio antenna 104. The close proximity wireless communication apparatus 12 on the sender side is provided with a system control unit 201, a close proximity wireless communication unit 202, a memory 203, a radio antenna 204, and an operation switch 207.

In this embodiment, the close proximity wireless communication apparatus 11 on the receiver side and the close proximity wireless communication apparatus 12 on the sender side are brought close to each other to establish close proximity wireless communication therebetween. This enables data communication (noncontact communication due to an approach within a predetermined distance) between the close proximity wireless communication apparatus 11 on the receiver side and the close proximity wireless communication apparatus 12 on the sender side.

In the close proximity wireless communication apparatus 11 on the receiver side, the system control unit 101 controls the entire system of the close proximity wireless communication apparatus 11. When the radio antenna 104 approaches to the radio antenna 204 due to approach of the close proximity wireless communication apparatus 11 on the receiver side to the close proximity wireless communication apparatus 12 on the sender side, the close proximity wireless communication unit 102 acquires intensity information of electric field strength required for close proximity wireless communication and outputs the acquired information to the system control unit 101. The memory 103 stores data. The close proximity wireless communication is established between the radio antenna 104 and the radio antenna 204 of the close proximity wireless communication apparatus 12 on the sender side.

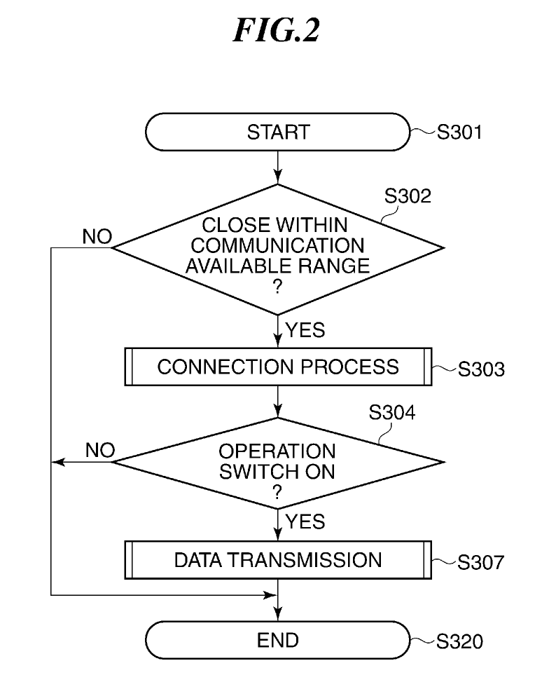

In the close proximity wireless communication apparatus 12 on the sender side, the system control unit 201 controls the entire system of the close proximity wireless communication apparatus 12. The system control unit 201 executes a process shown in a flowchart in FIG. 2 according to a control program. When the radio antenna 104 approaches to the radio antenna 204 due to approach of the close proximity wireless communication apparatus 11 on the receiver side to the close proximity wireless communication apparatus 12 on the sender side, the close proximity wireless communication unit 202 acquires intensity information of electric field strength required for close proximity wireless communication.

The memory 203 stores data. The close proximity wireless communication is established between the radio antenna 204 and the radio antenna 104 of the close proximity wireless communication apparatus 11 on the receiver side. The operation switch 207, which is fixed to the close proximity wireless communication apparatus 12, becomes ON condition only when an operator is pushing down it. The operation switch 207 is pushed down when instructing the data transmission from the close proximity wireless communication apparatus 12 on the sender side to the close proximity wireless communication apparatus 11 on the receiver side, for example.

It should be noted that this embodiment assumes the case where the close proximity wireless communication apparatus 11 on the receiver side and the close proximity wireless communication apparatus 12 on the sender side are mounted on any apparatuses in an apparatus group (for example, a personal digital assistant, a digital camera, a mobile phone, etc.). The close proximity wireless communication apparatus 11 on the receiver side and the close proximity wireless communication apparatus 12 on the sender side are used as wireless communication apparatuses that transmit the data stored in the memories (the memories 103 and 203) that are built in the apparatuses. In this embodiment and other embodiments, a personal digital assistant, a digital camera, or the like that is equipped with a close proximity wireless communication apparatus are described as a close proximity wireless communication apparatus for convenience.

Hereafter, operations of this embodiment will be described with reference to FIG. 1 and FIG. 2.

FIG. 2 is a flowchart showing a wireless communication process in the close proximity wireless communication apparatus 12 on the sender side when communicating with the close proximity wireless communication apparatus 11 on the receiver side. It should be noted that a wireless communication process of the close proximity wireless communication apparatus 11 on the receiver side is not shown in the flowchart, and is simply described or is not described partially.

In FIG. 2, the system control unit 201 of the close proximity wireless communication apparatus 12 on the sender side repeatedly starts this process at predetermined timing (step S301). Here, the predetermined timing to start this process is set so that an operator does not feel a delay of an operation of an apparatus (for example, a personal digital assistant, a digital camera, a mobile phone, etc.). For example, this process starts at every one second in this embodiment.

When the radio antenna 204 on the sender side approaches to the radio antenna 104 on the receiver side because the operator brings the close proximity wireless communication apparatus 12 on the sender side close to the close proximity wireless communication apparatus 11 on the receiver side, the electric field strength required for the close proximity wireless communication is obtained. This enables the close proximity wireless communication between the close proximity wireless communication apparatus 12 on the sender side and the close proximity wireless communication apparatus 11 on the receiver side. The system control unit 201 determines whether the radio antenna 204 on the sender side and the radio antenna 104 on the receiver side are close within the communication available range in which the data communication is possible based on the intensity information of the electric field strength obtained by the close proximity wireless communication unit 202 (step S302).

When the system control unit 201 determines that the radio antenna 204 on the sender side and the radio antenna 104 on the receiver side are not close within the communication available range in which the data communication is possible and that the electric field strength, etc. do not satisfy the communication condition, this process is finished (step S320). When the system control unit 201 determines that the radio antenna 204 on the sender side and the radio antenna 104 on the receiver side are close within the communication available range in which the data communication is possible, the process proceeds to step S303.

It should be noted that the determination in step S302 is not only executed by the system control unit 201 as in this embodiment, but also can be executed by the system control unit 101 or both the system control units 201 and 101.

When the radio antenna 204 on the sender side and the radio antenna 104 on the receiver side are close within the communication available range in which the data communication is possible, the system control unit 201 performs a connection process for transmitting the data through close proximity wireless communication, and secures a data transmission route (step S303). Here, the data transmission route is a path that passes along the close proximity wireless communication unit 202, the radio antenna 204, the radio antenna 104, and the close proximity wireless communication unit 102. When data transmission becomes available, the system control unit 201 determines whether the operator pushes the operation switch 207 (whether the operation switch 207 becomes ON condition) with which the close proximity wireless communication apparatus 12 on the sender side is equipped, or not (step S304).

When the operation switch 207 is not pushed, this process is finished (step S320). When the operation switch 207 is pushed (when the data transmission is instructed), the system control unit 201 performs the following control. The system control unit 201 controls the data transmission through the memory 203 and the close proximity wireless communication unit 202 so that the data stored in the memory 203 is transmitted to the memory 103 of the close proximity wireless communication apparatus 11 on the receiver side through the above-mentioned data transmission route (step S307). In this case, the system control unit 101 in the close proximity wireless communication apparatus 11 on the receiver side also controls the data transmission through the close proximity wireless communication unit 102 and the memory 103.

As described above, according to the embodiment, when the data is transmitted between the close proximity wireless communication apparatus 12 on the sender side and the close proximity wireless communication apparatus 11 on the receiver side, the operator brings the apparatus on the sender side close to the apparatus on the receiver side while pushing down the operation switch 207 of the apparatus on the sender side. Accordingly, since the data is transmitted from the memory of the apparatus on the sender side to the memory of the apparatus on the receiver side, the data transmission becomes available without complicated operations. Further, unintentional data transmission to another apparatus can be prevented even if an operator does not perform complicated operations to register apparatuses that permit data transmission.

When the data is transmitted between the close proximity wireless communication apparatus 12 on the sender side and the close proximity wireless communication apparatus 11 on the receiver side, the data transmission is restricted so as to be executed only when the operator pushes down the operation switch 207. Accordingly, it is also possible to prevent the data of the sender side from transmitting to another apparatus without sender's knowing.

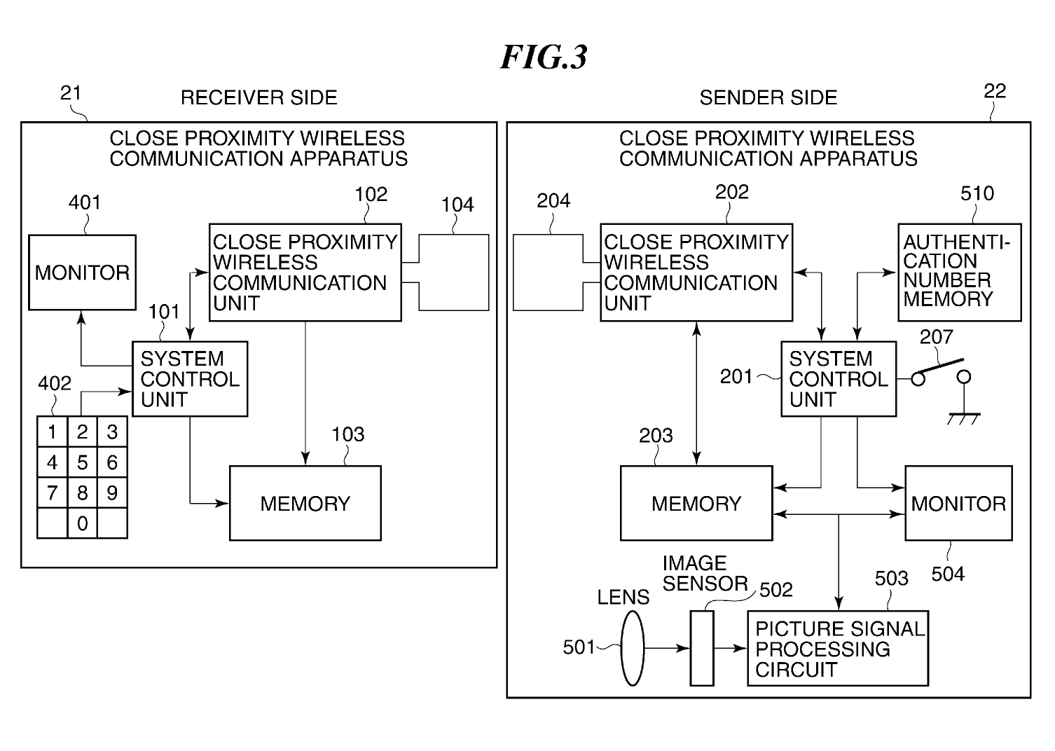

FIG. 3 is a block diagram showing a configuration of a close proximity wireless communication apparatus on a sender side and a close proximity wireless communication apparatus on a receiver side according to a second embodiment of the present invention.

In FIG. 3, the close proximity wireless communication apparatus 21 on the receiver side is provided with a system control unit 101, a close proximity wireless communication unit 102, a memory 103, a radio antenna 104, a monitor 401, and an operation switch group 402. The close proximity wireless communication apparatus 22 on the sender side is provided with a system control unit 201, a close proximity wireless communication unit 202, a memory 203, a radio antenna 204, and an operation switch 207. The close proximity wireless communication apparatus 22 on the sender side is further provided with a lens 501, an image sensor 502, a picture signal processing circuit 503, a monitor 504, and an authentication number memory 510.

The close proximity wireless communication apparatus 21 on the receiver side includes a plurality of key switches (an operation switch group 402) with which a mobile phone is equipped, for example, and functions as a wireless communication apparatus of the mobile phone. The close proximity wireless communication apparatus 22 on the sender side includes the elements (the memory 203, the lens 501, the image sensor 502, the picture signal processing circuit 503, and the monitor 504) with which a digital camera (an imaging device) is equipped, for example, and functions as wireless communication apparatus of a digital camera. It should be noted that components shown in FIG. 3 and having the same functions as the components shown in FIG. 1 are denoted by the identical numerals and the descriptions thereof are omitted. Hereinafter, differences will be mainly described.

In the close proximity wireless communication apparatus 21 on the receiver side, the monitor 401 displays operator-oriented notice information, for example information notifying that data transmission from the close proximity wireless communication apparatus 12 on the sender side to the close proximity wireless communication apparatus 11 on the receiver side has been executed, etc. The operation switch group 402 consists of a plurality of key switches that are used for inputting a numeric value, data, etc. The monitor 401 and the operation switch group 402 are equivalent to a display unit and an operation unit with which the mobile phone is equipped, for example.

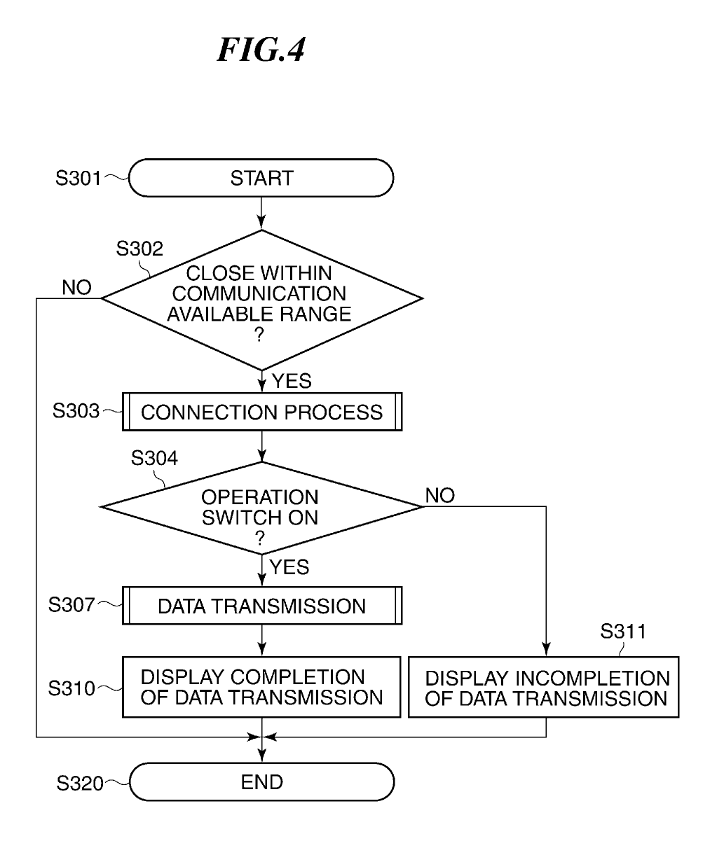

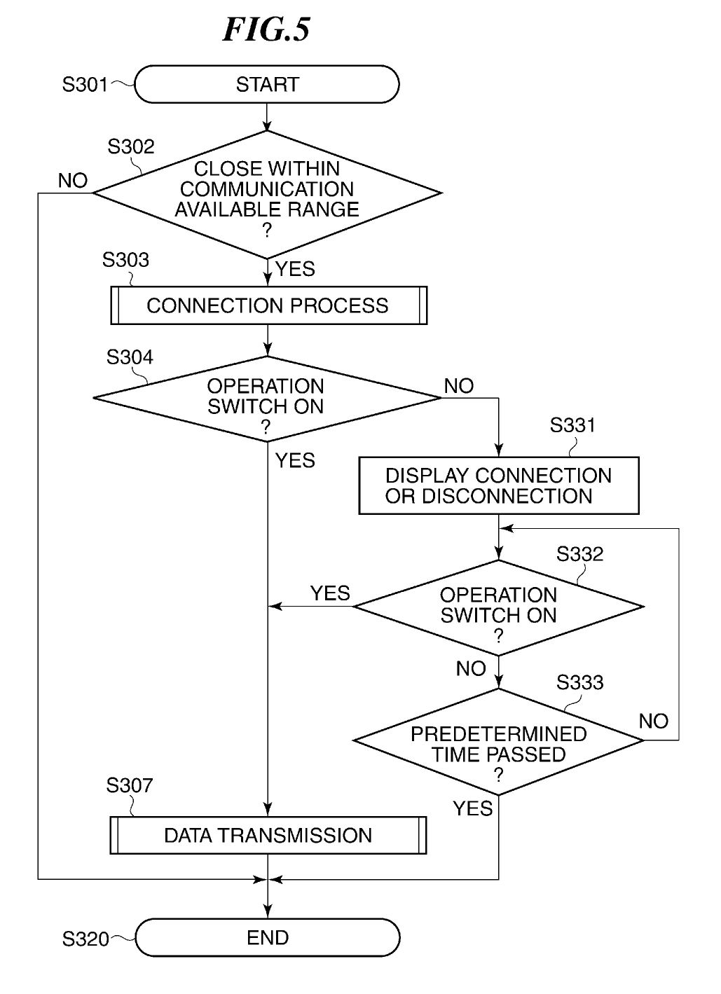

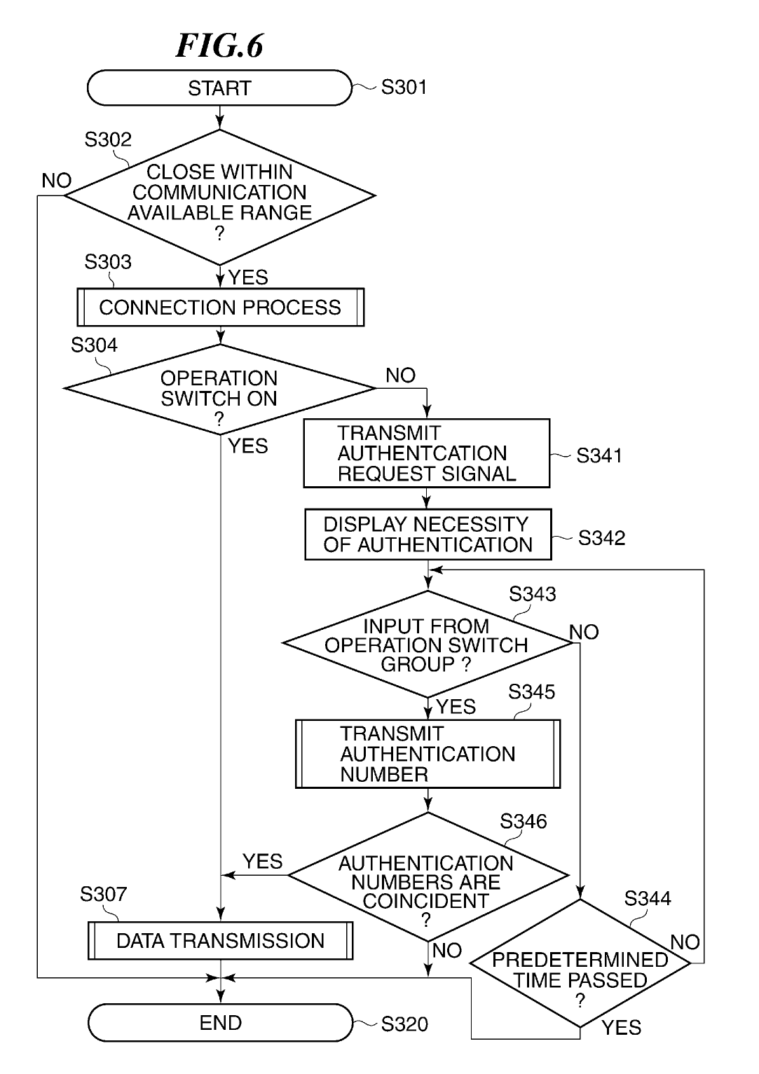

In the close proximity wireless communication apparatus 22 on the sender side, the system control unit 201 executes processes shown in the respective flowcharts of FIG. 4, FIG. 5, and FIG. 6, based on a control program. The lens 501 constitutes an imaging optical system and forms an optical image of an object onto the image sensor 502. The image sensor 502 consists of a CCD (a charge-coupled device), for example, and photoelectrically converts the optical image of the object formed by the lens 501 into an imaging signal. The picture signal processing circuit 503 generates image data based on the imaging signal outputted from the image sensor 502.

The monitor 504 displays a captured image, operator-oriented notice information, for example information notifying whether data transmission from the close proximity wireless communication apparatus 22 on the sender side to the close proximity wireless communication apparatus 21 on the receiver side has been executed, etc. An authentication number for authentication is registered into the authentication number memory 510. The authentication number is information that identifies an apparatus to which data transmission from the close proximity wireless communication apparatus 22 on the sender side is permitted.

Here, operations of the close proximity wireless communication apparatus 22 on the sender side as a digital camera will be described briefly. For example, it is assumed that an operator has operated a mode change switch with which the close proximity wireless communication apparatus 22 on the sender side is equipped to change the mode from a data transmission mode for transmitting data to a digital camera photographing mode for taking a picture. The system control unit 201 shifts the mode of the close proximity wireless communication apparatus 22 to the digital camera photographing mode in response to the operation signal of the mode change switch.

When the mode of the close proximity wireless communication apparatus 22 on the sender side is shifted to the digital camera photographing mode, incident light through the lens 501 forms an optical image of an object on the image sensor 502, and then, the imaging signal that is photoelectrically converted by the image sensor 502 can be acquired. The imaging signal is converted into a picture data format by the picture signal processing circuit 503. The converted imaging signal is displayed on the monitor 504 as an image, and is stored into the memory 203 as image data when the operator operates a photographing switch. It should be noted that the photographing switch can double as the operation switch 207.

Hereafter, operations of this embodiment will be described with reference to FIG. 3 and FIG. 4.

FIG. 4 is a flowchart showing a wireless communication process in the close proximity wireless communication apparatus 22 on the sender side when communicating with the close proximity wireless communication apparatus 21 on the receiver side. It should be noted that a wireless communication process of the close proximity wireless communication apparatus 21 on the receiver side is not shown in a flowchart, and is simply described or is not described partially. In FIG. 4, the same step number is attached to the same process as in FIG. 2.

In FIG. 4, the system control unit 201 of the close proximity wireless communication apparatus 22 on the sender side repeatedly starts this process at predetermined timing (step S301). Here, the predetermined timing to start this process is set so that an operator does not feel a delay of an operation of an apparatus. For example, this process starts at every one second in this embodiment.

When the radio antenna 204 on the sender side approaches to the radio antenna 104 on the receiver side because the operator brings the close proximity wireless communication apparatus 22 on the sender side close to the close proximity wireless communication apparatus 21 on the receiver side, the electric field strength required for the close proximity wireless communication is obtained. This enables the close proximity wireless communication between the close proximity wireless communication apparatus 22 on the sender side and the close proximity wireless communication apparatus 21 on the receiver side. The system control unit 201 determines whether the radio antenna 204 on the sender side and the radio antenna 104 on the receiver side are close within the communication available range in which the data communication is possible based on the intensity information of the electric field strength obtained by the close proximity wireless communication unit 202 (step S302).

When the system control unit 201 determines that the radio antenna 204 on the sender side and the radio antenna 104 on the receiver side are not close within the communication available range in which the data communication is possible and that the electric field strength, etc. do not satisfy the communication condition, this process is finished (step S320). When the system control unit 201 determines that the radio antenna 204 on the sender side and the radio antenna 104 on the receiver side are close within the communication available range in which the data communication is possible, the process proceeds to step S303.

It should be noted that the determination in step S302 is not only executed by the system control unit 201 as in this embodiment, but also can be executed by the system control unit 101 or both the system control units 201 and 101.

When the radio antenna 204 on the sender side and the radio antenna 104 on the receiver side are close within the communication available range in which the data communication is possible, the system control unit 201 performs a connection process for transmitting the data through close proximity wireless communication, and secures a data transmission route (step S303). Here, the data transmission route is a path that passes along the close proximity wireless communication unit 202, the radio antenna 204, the radio antenna 104, and the close proximity wireless communication unit 102. When data transmission becomes available, the system control unit 201 determines whether the operator pushes the operation switch 207 (whether the operation switch 207 becomes ON condition) with which the close proximity wireless communication apparatus 22 on the sender side is equipped, or not (step S304).

When the operation switch 207 is pushed (when the data transmission is instructed), the system control unit 201 performs the following control. The system control unit 201 controls the data transmission (sending) through the memory 203 and the close proximity wireless communication unit 202 so that the data stored in the memory 203 is transmitted to the memory 103 of the close proximity wireless communication apparatus 21 on the receiver side through the above-mentioned data transmission route (step S307). In this case, the system control unit 101 in the close proximity wireless communication apparatus 21 on the receiver side also controls the data transmission (reception) through the close proximity wireless communication unit 102 and the memory 103.

Further, the system control unit 201 displays that the data transmission has been completed on the monitor 504 (step S310). In this case, the system control unit 201 of the close proximity wireless communication apparatus 21 on the receiver side also displays that the data transmission has been completed on the monitor 401.

When the operation switch 207 is not pushed, the system control unit 201 displays that the data communication has been performed but the data transmission has not been completed on the monitor 504 (step S311). In this case, the system control unit 101 of the close proximity wireless communication apparatus 21 also displays that the data communication has been performed but the data transmission has not been completed on the monitor 401.

As described above, according to the embodiment, when the data is transmitted between the close proximity wireless communication apparatus 22 on the sender side and the close proximity wireless communication apparatus 21 on the receiver side, the operator brings the apparatus on the sender side close to the apparatus on the receiver side while pushing down the operation switch 207 of the apparatus on the sender side. Accordingly, since the data is transmitted from the memory of the apparatus on the sender side to the memory of the apparatus on the receiver side, the data transmission becomes available without complicated operations. Further, unintentional data transmission to another apparatus can be prevented even if an operator does not perform complicated operations to register apparatuses that permit data transmission.

When transmitting data between the close proximity wireless communication apparatus 22 on the sender side and the close proximity wireless communication apparatus 21 on the receiver side, whether the data transmission has been completed (executed) or not is displayed on the monitor 504 of the apparatus on the sender side and the monitor 401 of the apparatus on the receiver side. Accordingly, the operator can confirm the completion or incompletion of the data transmission.

A third embodiment of the present invention is different from the above-mentioned second embodiment in the following points. Since the other elements of this embodiment are identical to the corresponding elements in the above-mentioned second embodiment (FIG. 3), their descriptions are omitted.

Hereafter, operations of this embodiment will be described with reference to FIG. 3 and FIG. 5.

FIG. 5 is a flowchart showing a wireless communication process in the close proximity wireless communication apparatus 22 on the sender side when communicating with the close proximity wireless communication apparatus 21 on the receiver side. It should be noted that the wireless communication process of the close proximity wireless communication apparatus 21 on the receiver side is not shown in the flowchart, and is simply described or is not described partially. In FIG. 5, the same step number is attached to the same process as in FIG. 2.

In FIG. 5, the system control unit 201 of the close proximity wireless communication apparatus 22 on the sender side repeatedly starts this process at predetermined timing (step S301). Here, the predetermined timing to start this process is set so that an operator does not feel a delay of an operation of an apparatus (a device). For example, this process starts at every one second in this embodiment.

When the radio antenna 204 on the sender side approaches to the radio antenna 104 on the receiver side because the operator brings the close proximity wireless communication apparatus 22 on the sender side close to the close proximity wireless communication apparatus 21 on the receiver side, the electric field strength required for the close proximity wireless communication is obtained. This enables the close proximity wireless communication between the close proximity wireless communication apparatus 22 on the sender side and the close proximity wireless communication apparatus 21 on the receiver side. The system control unit 201 determines whether the radio antenna 204 on the sender side and the radio antenna 104 on the receiver side are close within the communication available range in which the data communication is possible based on the intensity information of the electric field strength obtained by the close proximity wireless communication unit 202 (step S302).

When the system control unit 201 determines that the radio antenna 204 on the sender side and the radio antenna 104 on the receiver side are not close within the communication available range in which the data communication is possible and that the electric field strength, etc. do not satisfy the communication condition, this process is finished (step S320). When the system control unit 201 determines that the radio antenna 204 on the sender side and the radio antenna 104 on the receiver side are close within the communication available range in which the data communication is possible, the process proceeds to step S303.

It should be noted that the determination in step S302 is not only executed by the system control unit 201 as in this embodiment, but also can be executed by the system control unit 101 or both the system control units 201 and 101.

When the radio antenna 204 on the sender side and the radio antenna 104 on the receiver side are close within the communication available range in which the data communication is possible, the system control unit 201 performs a connection process for transmitting the data through close proximity wireless communication, and secures a data transmission route (step S303). Here, the data transmission route is a path that passes along the close proximity wireless communication unit 202, the radio antenna 204, the radio antenna 104, and the close proximity wireless communication unit 102. When data transmission becomes available, the system control unit 201 determines whether the operator pushes the operation switch 207 (whether the operation switch 207 becomes ON condition) with which the close proximity wireless communication apparatus 22 on the sender side is equipped, or not (step S304).

When the operation switch 207 is pushed (when the data transmission is instructed), the system control unit 201 performs the following control. The system control unit 201 controls the data transmission (sending) through the memory 203 and the close proximity wireless communication unit 202 so that the data stored in the memory 203 is transmitted to the memory 103 of the close proximity wireless communication apparatus 21 on the receiver side through the above-mentioned data transmission route (step S307). In this case, the system control unit 101 in the close proximity wireless communication apparatus 21 on the receiver side also controls the data transmission (reception) through the close proximity wireless communication unit 102 and the memory 103.

When the operation switch 207 is not pushed, the system control unit 201 displays the information about the connection or disconnection for data transmission on the monitor 504 (step S331). In this embodiment, a message “Data transmission has not been executed. Push an operation switch within 10 seconds for executing data transmission.” is displayed. An indication to urge an operation of the operation switch 207 is enough as the information about the connection or disconnection.

Then, the system control unit 201 determines whether the operation switch 207 has been pushed (step S332). When the operation switch 207 is not pushed, the process proceeded to step S307 and a data transmission control is performed. When the operation switch 207 is pushed, the system control unit 201 determines whether a predetermined time passed after starting the processing of step S333 concerned first (step S333). When the time that is passed after starting the process of step S333 concerned first is less than 10 seconds, for example, the process is returned to step S332. When the time that is passed after starting the process of step S333 concerned first exceeds 10 seconds, this process is finished (step S320).

As described above, according to the embodiment, when the data is transmitted between the close proximity wireless communication apparatus 22 on the sender side and the close proximity wireless communication apparatus 21 on the receiver side, the operator brings the apparatus on the sender side close to the apparatus on the receiver side while pushing down the operation switch 207 of the apparatus on the sender side. Accordingly, since the data is transmitted from the memory of the apparatus on the sender side to the memory of the apparatus on the receiver side, the data transmission becomes available without complicated operations. Further, unintentional data transmission to another apparatus can be prevented even if an operator does not perform complicated operations to register apparatuses that permit data transmission.

Even if the operator does not push down the operation switch 207 during the approach of the close proximity wireless communication apparatus 22 on the sender side to the close proximity wireless communication apparatus 21 on the receiver side, the indication that shows such a situation and the indication to urge an operation to execute the data transmission are displayed on the monitor of the apparatus on the sender side. This enables to continue the data transmission.

A fourth embodiment of the present invention is different from the above-mentioned second embodiment in the following points. Since the other elements of this embodiment are identical to the corresponding elements in the above-mentioned second embodiment (FIG. 3), their descriptions are omitted.

Hereafter, operations of this embodiment will be described with reference to FIG. 3 and FIG. 6.

FIG. 6 is a flowchart showing a wireless communication process in the close proximity wireless communication apparatus 22 on the sender side and the close proximity wireless communication apparatus 21 on the receiver side. In FIG. 6, the same step number is attached to the same process as in FIG. 2.

In FIG. 6, the system control unit 201 of the close proximity wireless communication apparatus 22 on the sender side repeatedly starts this process at predetermined timing (step S301). Here, the predetermined timing to start this process is set so that an operator does not feel a delay of an operation of an apparatus (a device). For example, this process starts at every one second in this embodiment.

When the radio antenna 204 on the sender side approaches to the radio antenna 104 on the receiver side because the operator brings the close proximity wireless communication apparatus 22 on the sender side close to the close proximity wireless communication apparatus 21 on the receiver side, the electric field strength required for the close proximity wireless communication is obtained. This enables the close proximity wireless communication between the close proximity wireless communication apparatus 22 on the sender side and the close proximity wireless communication apparatus 21 on the receiver side. The system control unit 201 determines whether the radio antenna 204 on the sender side and the radio antenna 104 on the receiver side are close within the communication available range in which the data communication is possible based on the intensity information of the electric field strength obtained by the close proximity wireless communication unit 202 (step S302).

When the system control unit 201 determines that the radio antenna 204 on the sender side and the radio antenna 104 on the receiver side are not close within the communication available range in which the data communication is possible and that the electric field strength, etc. do not satisfy the communication condition, this process is finished (step S320). When the system control unit 201 determines that the radio antenna 204 on the sender side and the radio antenna 104 on the receiver side are close within the communication available range in which the data communication is possible, the process proceeds to step S303.

It should be noted that the determination in step S302 is not only executed by the system control unit 201 as in this embodiment, but also can be executed by the system control unit 101 or both the system control units 201 and 101.

When the radio antenna 204 on the sender side and the radio antenna 104 on the receiver side are close within the communication available range in which the data communication is possible, the system control unit 201 performs a connection process for transmitting the data through close proximity wireless communication, and secures a data transmission route (step S303). Here, the data transmission route is a path that passes along the close proximity wireless communication unit 202, the radio antenna 204, the radio antenna 104, and the close proximity wireless communication unit 102. When data transmission becomes available, the system control unit 201 determines whether the operator pushes the operation switch 207 (whether the operation switch 207 becomes ON condition) with which the close proximity wireless communication apparatus 22 on the sender side is equipped, or not (step S304).

When the operation switch 207 is pushed, the system control unit 201 performs the following control. The system control unit 201 controls the data transmission (sending) through the memory 203 and the close proximity wireless communication unit 202 so that the data stored in the memory 203 is transmitted to the memory 103 of the close proximity wireless communication apparatus 21 on the receiver side through the above-mentioned data transmission route (step S307). In this case, the system control unit 101 in the close proximity wireless communication apparatus 21 on the receiver side also controls the data transmission (reception) through the close proximity wireless communication unit 102 and the memory 103.

When the operation switch 207 is not pushed, the system control unit 201 transmits the following data. The system control unit 201 transmits an authentication request signal for transmitting data to the system control unit 101 of the close proximity wireless communication apparatus 21 on the receiver side by the wireless communication through the close proximity wireless communication units 202 and 102 (step S341).

On the other hand, the system control unit 101 of the close proximity wireless communication apparatus 21 on the receiver side displays necessity of an authentication on the monitor 401, when the authentication request signal is received from the close proximity wireless communication apparatus on the sender side 22 (step S342). In this embodiment, an indication to urge to input the authentication number for authentication (the authentication information) that is registered beforehand in the authentication number memory 510 of the close proximity wireless communication apparatus 22 on the sender side from the operation switch group 402 is displayed.

The system control unit 101 determines whether the authentication number for authentication has been inputted from the operation switch group 402 (step S343). When the authentication number has not been inputted from the operation switch group 402, the system control unit 101 determines whether a predetermined time passed after starting the process of the step S344 concerned first (step S344). When the time that is passed after starting the process of step S344 concerned first is less than 10 seconds, for example, the process is returned to step S343. When the time that is passed after starting the process of step S344 concerned first exceeds 10 seconds, this process is finished (step S320).

When the authentication number has been inputted from the operation switch group 402, the system control unit 101 transmits the following data. The system control unit 101 transmits the authentication number (the authentication information), which is inputted from the operation switch group 402, to the system control unit 201 of the close proximity wireless communication apparatus 22 on the sender side by the wireless communication through the close proximity wireless communication units 102 and 202 (step S345).

The system control unit 201 of the close proximity wireless communication apparatus 22 on the sender side compares the authentication number transmitted from the system control unit 101 of the close proximity wireless communication apparatus 21 on the receiver side with the authentication number registered in the authentication number memory 510. Further, the system control unit 201 determines whether both the authentication numbers are coincident (step S346).

That is, the system control unit 201 determines whether the close proximity wireless communication apparatus 21 on the receiver side has been registered beforehand as an apparatus that permits data transmission based on whether both the authentication numbers are coincident. When both the authentication numbers are coincident, the system control unit 201 authenticates the apparatus 21, proceeds with the process to step S307, and performs data transmission control. When both the authentication numbers are not coincident, this process is finished (step S320).

It should be noted that information about whether the data transmission from the close proximity wireless communication apparatus 22 on the sender side to the proximity wireless on the communication apparatus 21 on the receiver side has been executed (completed) may be displayed on the monitor 504 of the apparatus on the sender side in the process shown in FIG. 6 in the same manner as the above-mentioned second embodiment. It may be displayed on the monitor 401 of the apparatus on the receiver side.

As described above, according to the embodiment, when the data is transmitted between the close proximity wireless communication apparatus 22 on the sender side and the close proximity wireless communication apparatus 21 on the receiver side, the operator brings the apparatus on the sender side close to the apparatus on the receiver side while pushing down the operation switch 207 of the apparatus on the sender side. Accordingly, since the data is transmitted from the memory of the apparatus on the sender side to the memory of the apparatus on the receiver side, the data transmission becomes available without complicated operations. Further, unintentional data transmission to another apparatus can be prevented even if an operator does not perform complicated operations to register an apparatus that permits data transmission.

Even if the operator does not push down the operation switch 207 during the approach of the close proximity wireless communication apparatus 22 on the sender side to the close proximity wireless communication apparatus 21 on the receiver side, the indication that shows such a situation and the indication to urge to input the authentication number are displayed on the monitor of the apparatus on the receiver side. Accordingly, the authentication number, which is inputted to the apparatus on the receiver side, is transmitted to the apparatus on the sender side, and when the transmitted authentication number is coincident with the authentication number registered in the apparatus on the sender side, the data transmission control is performed. This enables to continue the data transmission.

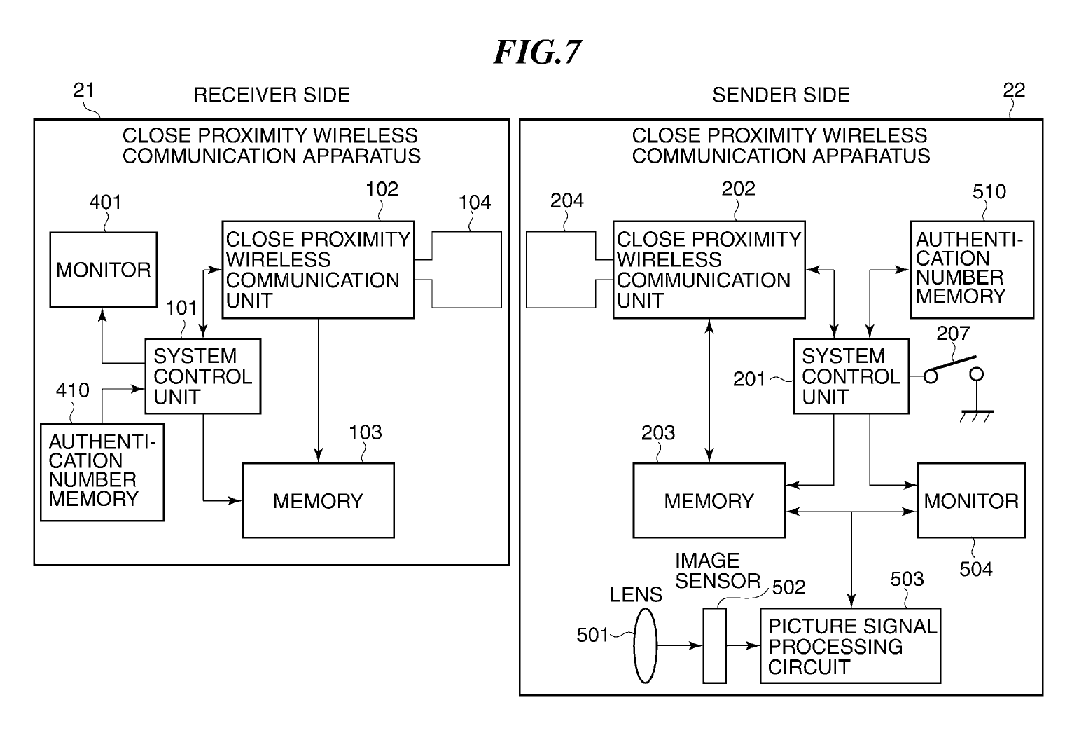

FIG. 7 is a block diagram showing a configuration of a close proximity wireless communication apparatus on a sender side and a close proximity wireless communication apparatus on a receiver side according to a fifth embodiment of the present invention. It should be noted that the configuration shown in FIG. 7 is an example for embodying an authentication unit, an instruction unit, a determination unit, a control unit, and a registration unit of the present invention.

In FIG. 7, the close proximity wireless communication apparatus 21 (an external apparatus) on the receiver side is provided with a system control unit 101, a close proximity wireless communication unit 102, a memory 103, a radio antenna 104, a monitor 401, and an authentication memory 410. The close proximity wireless communication apparatus 22 (a wireless communication apparatus) on the sender side is provided with a system control unit 201 (the authentication unit, the determination unit, and the control unit), a close proximity wireless communication unit 202, a memory 203, a radio antenna 204, and an operation switch 207 (the instruction unit). The close proximity wireless communication apparatus 22 on the sender side is provided with a lens 501, an image sensor 502, a picture signal processing circuit 503, a monitor 504 (the display unit), and an authentication number memory 510 (the registration unit).

The close proximity wireless communication apparatus 21 on the receiver side is equipped with the authentication number memory 410 as mentioned above. In the authentication number memory 410, the authentication number of its own apparatus (that is, the close proximity wireless communication apparatus 21 in itself on the receiver side) is registered.

The close proximity wireless communication apparatus 22 on the sender side includes the components (the memory 203, the lens 501, the image sensor 502, the picture signal processing circuit 503, and the monitor 504) with which a digital camera (an imaging device), for example, is equipped, and functions as a wireless communication apparatus of a digital camera. It should be noted that the components shown in FIG. 7 and having the same functions as the components shown in FIG. 1 are denoted by the identical numerals and the descriptions thereof are omitted. Hereinafter, different points will be mainly described.

In the close proximity wireless communication apparatus 21 on the receiver side, the monitor 401 displays operator-oriented notice information (information notifying whether data transmission from the close proximity wireless communication apparatus 22 on the sender side to the close proximity wireless communication apparatus 21 on the receiver side has been executed (completed)), etc. In the authentication number memory 410, the authentication number (authentication information) of its own apparatus is registered as described above.

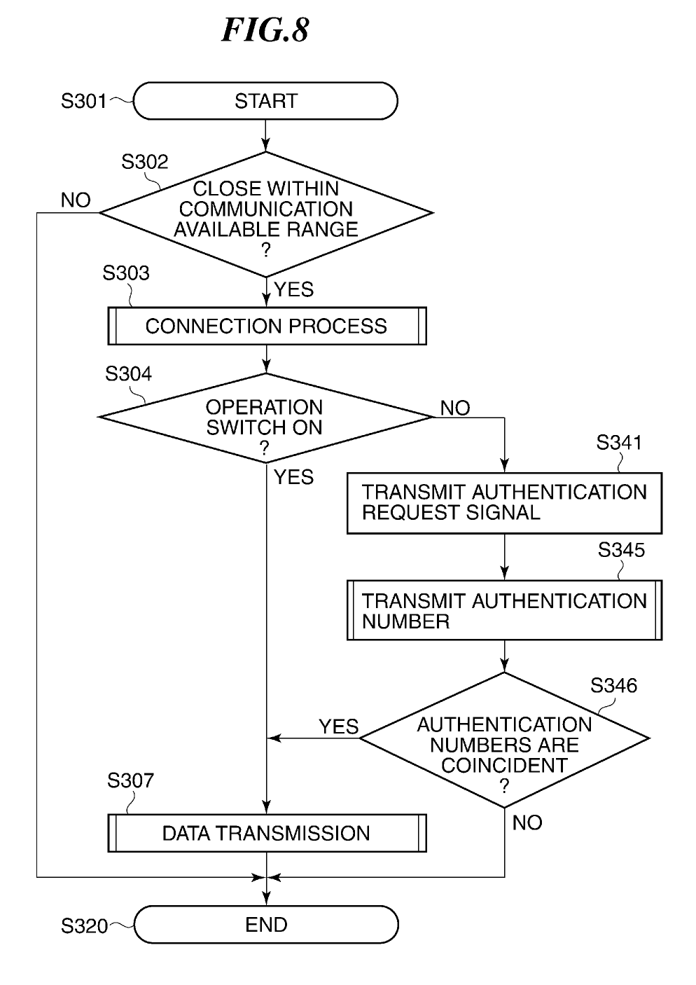

In the close proximity wireless communication apparatus 22 on the sender side, the system control unit 201 executes a process shown in a flowchart in FIG. 8 according to a control program. The lens 501 constitutes an imaging optical system and forms an optical image of an object onto the image sensor 502. The image sensor 502 consists of a CCD (a charge-coupled device), for example, and photoelectrically converts the optical image of the object formed by the lens 501 into an imaging signal. The picture signal processing circuit 503 generates image data based on the imaging signal outputted from the image sensor 502.

The monitor 504 displays a captured image, the operator-oriented notice information (information notifying whether data transmission from the close proximity wireless communication apparatus 22 on the sender side to the close proximity wireless communication apparatus 21 on the receiver side has been executed (completed)), etc. In the authentication number memory 510, the authentication numbers (authentication information) for authentication of a plurality of apparatuses are registered. The authentication number is information that identifies an apparatus (a device) that permits close proximity wireless communication with the close proximity wireless communication apparatus 22 on the sender side.

It should be noted that since operations of the close proximity wireless communication apparatus 22 on the sender side as a digital camera are identical to the corresponding operations of the above-mentioned second embodiment (FIG. 3), the descriptions thereof are omitted.

Hereafter, operations of this embodiment will be described with reference to FIG. 7 and FIG. 8.

FIG. 8 is a flowchart showing a wireless communication process in the close proximity wireless communication apparatus 22 on the sender side and the close proximity wireless communication apparatus 21 on the receiver side. In FIG. 8, the same step number is attached to the same process as in FIG. 6.

In FIG. 8, the system control unit 201 of the close proximity wireless communication apparatus 22 on the sender side repeatedly starts this process at predetermined timing (step S301). Here, the predetermined timing to start this process is set so that an operator does not feel a delay of an operation of an apparatus (a device). For example, this process starts at every one second in this embodiment.

When the radio antenna 204 on the sender side approaches to the radio antenna 104 on the receiver side because the operator brings the close proximity wireless communication apparatus 22 on the sender side close to the close proximity wireless communication apparatus 21 on the receiver side, the electric field strength required for the close proximity wireless communication is obtained. This enables the close proximity wireless communication between the close proximity wireless communication apparatus 22 on the sender side and the close proximity wireless communication apparatus 21 on the receiver side. The system control unit 201 determines whether the radio antenna 204 on the sender side and the radio antenna 104 on the receiver side are close within the communication available range in which the data communication is possible based on the intensity information of the electric field strength obtained by the close proximity wireless communication unit 202 (step S302).

When the system control unit 201 determines that the radio antenna 204 on the sender side and the radio antenna 104 on the receiver side are not close within the communication available range in which the data communication is possible and that the electric field strength, etc. do not satisfy the communication condition, this process is finished (step S320). When the system control unit 201 determines that the radio antenna 204 on the sender side and the radio antenna 104 on the receiver side are close within the communication available range in which the data communication is possible, the process proceeds to step S303.

It should be noted that the determination in step S302 is not only executed by the system control unit 201 as in this embodiment, but also can be executed by the system control unit 101 or both the system control units 201 and 101.

When the radio antenna 204 on the sender side and the radio antenna 104 on the receiver side are close within the communication available range in which the data communication is possible, the system control unit 201 performs a connection process for transmitting the data through close proximity wireless communication, and secures a data transmission route (step S303). Here, the data transmission route is a path that passes along the close proximity wireless communication unit 202, the radio antenna 204, the radio antenna 104, and the close proximity wireless communication unit 102. When data transmission becomes available, the system control unit 201 determines whether the operator pushes the operation switch 207 (whether the operation switch 207 becomes ON condition) with which the close proximity wireless communication apparatus 22 on the sender side is equipped, or not (step S304).

When the operation switch 207 is pushed, the system control unit 201 performs the following control. The system control unit 201 controls the data transmission (sending) through the memory 203 and the close proximity wireless communication unit 202 so that the data stored in the memory 203 is transmitted to the memory 103 of the close proximity wireless communication apparatus 21 on the receiver side through the above-mentioned data transmission route (step S307). In this case, the system control unit 101 in the close proximity wireless communication apparatus 21 on the receiver side also controls the data transmission (reception) through the close proximity wireless communication unit 102 and the memory 103.

When the operation switch 207 is not pushed, the system control unit 201 transmits the following data. The system control unit 201 transmits an authentication request signal for transmitting data to the system control unit 101 of the close proximity wireless communication apparatus 21 on the receiver side by the wireless communication through the close proximity wireless communication units 202 and 102 (step S341).

On the other hand, receiving the authentication request signal from the close proximity wireless communication apparatus 22 on the sender side, the system control unit 101 of the close proximity wireless communication apparatus 21 on the receiver side refers to the authentication number that has been registered beforehand in the authentication number memory 410 on the receiver side. And the system control unit 101 reads the authentication number (authentication information), and transmits it to the system control unit 201 of the close proximity wireless communication apparatus 22 on the sender side by the wireless communication through the close proximity wireless communication units 102 and 202 (step S345).

The system control unit 201 of the close proximity wireless communication apparatus 22 on the sender side compares the authentication number transmitted from the system control unit 101 of the close proximity wireless communication apparatus 21 on the receiver side with the authentication numbers registered in the authentication number memory 510. Further, the system control unit 201 determines whether the authentication number transmitted from the system control unit 101 is coincident with any authentication numbers registered in the authentication number memory 510 (step S346).

That is, the system control unit 201 determines whether the close proximity wireless communication apparatus 21 has been registered beforehand as an apparatus that permits data transmission based on whether the transmitted authentication number is coincident with any one of the registered authentication numbers. When the transmitted authentication number is coincident with any one of the registered authentication numbers, the system control unit 201 authenticates the apparatus 21, proceeds with the process to step S307, and controls data transmission. When the transmitted authentication number is not coincident with any of the registered authentication numbers, this process is finished (step S320).

It should be noted that information about whether the data transmission from the close proximity wireless communication apparatus 22 on the sender side to the proximity wireless on the communication apparatus 21 on the receiver side has been executed (completed) may be displayed on the monitor 504 of the apparatus on the sender side in the process shown in FIG. 8 in the same manner as the above-mentioned second embodiment. It may be displayed on the monitor 401 of the apparatus on the receiver side.

As described above, according to the embodiment, when the data is transmitted between the close proximity wireless communication apparatus 22 on the sender side and the close proximity wireless communication apparatus 21 on the receiver side, the operator brings the apparatus on the sender side close to the apparatus on the receiver side while pushing down the operation switch 207 of the apparatus on the sender side. Accordingly, since the data is transmitted from the memory of the apparatus on the sender side to the memory of the apparatus on the receiver side, the data transmission becomes available without complicated operations. Further, unintentional data transmission to another apparatus can be prevented.

According to this embodiment, the authentication number of the apparatus that permits data transmission is beforehand registered into the sender side apparatus and the receiver side apparatus. When the authentication number is transmitted to the sender side apparatus from the receiver side apparatus and the authentication number registered into the sender side apparatus is coincident with the transmitted authentication number, data transmission is controlled by the sender side apparatus. This allows automatic authentication without an operation of a user even if the sender side apparatus is brought close to the receiver side apparatus while not pushing the operation switch of the sender side apparatus. That is, the user of the receiver side apparatus does not need to input the authentication number, and an error-free data transmission can be realized by easy operations.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out the program code stored in the storage medium.

In this case, the program code itself read from the storage medium realizes the functions of any of the embodiments described above, and hence the program code and the storage medium in which the program code is stored constitute the present invention.

Examples of the storage medium for supplying the program code include a floppy (registered trademark) disk, a hard disk, an optical disk, a magnetic-optical disk, a CD-ROM, a CD-R, a CD-RW, DVD-ROM, a DVD-RAM, a DVD-RW, a DVD+RW, a magnetic tape, a nonvolatile memory card, a ROM, etc. Alternatively, the program may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

While the present invention has been described with reference to exemplary embodiments and it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2008-170751, filed on Jun. 30, 2008, which is hereby incorporated by reference herein in its entirety.

What is claimed is:

1. A wireless communication apparatus that performs close proximity wireless communication with an external apparatus if approaching to the external apparatus within a predetermined distance, the wireless communication apparatus comprising:
an authentication unit adapted to authenticate the external apparatus if the external apparatus is registered beforehand as an apparatus that permits data transmission to the wireless communication apparatus;
an instruction unit adapted to instruct transmission of data stored in the wireless communication apparatus;
a determination unit adapted to determine whether data transmission is instructed by the instruction unit if the wireless communication apparatus and the external apparatus are close within the communication available range; and
a control unit adapted to transmit data to the external apparatus after authentication of the external apparatus by the authentication unit if the determination unit determines that the data transmission has not been instructed, and to transmit data to the external apparatus without authentication by the authentication unit if the determination unit determines that the data transmission has been instructed by the instruction unit.

2. The wireless communication apparatus according to claim 1, further comprising a registration unit adapted to register authentication information identifying an external apparatus that permits data transmission to the wireless communication apparatus,
wherein the control unit requests the authentication information from the external apparatus if the determination unit determines that the instruction unit has not instructed data transmission,
wherein the control unit compares the authentication information registered in the registration unit to the authentication information transmitted from the external apparatus if the authentication information has been transmitted from the external apparatus, and
wherein the control unit transmits data to the external apparatus if both values of the authentication information are coincident.

3. The wireless communication apparatus according to claim 1, further comprising a display unit adapted to display information,
wherein the control unit displays information about whether the data transmission from the wireless communication apparatus to the external apparatus has been executed on the display unit.

4. The wireless communication apparatus according to claim 1, wherein the wireless communication apparatus is mounted to any device selected from a device group including a personal digital assistant, a mobile phone, and an imaging device.

5. A control method for a wireless communication apparatus that performs close proximity wireless communication with an external apparatus if approaching to the external apparatus within a predetermined distance, the control method comprising:
authenticating the external apparatus if the external apparatus is registered beforehand as an apparatus that permits data transmission to the wireless communication apparatus;
instructing transmission of data stored in the wireless communication apparatus;
determining whether data transmission is instructed if the wireless communication apparatus and the external apparatus are close within the communication available range;
transmitting data to the external apparatus after authentication of the external apparatus if it is determined that the data transmission has not been instructed; and
transmitting data to the external apparatus without authentication if it is determined that the data transmission has been instructed.

6. A computer-readable storage medium storing a control program executing a control method for a wireless communication apparatus that performs close proximity wireless communication with an external apparatus if approaching to the external apparatus within a predetermined distance, the control method comprising:
authenticating the external apparatus if the external apparatus is registered beforehand as an apparatus that permits data transmission to the wireless communication apparatus;
instructing transmission of data stored in the wireless communication apparatus;
determining whether data transmission is instructed if the wireless communication apparatus and the external apparatus are close within the communication available range;
transmitting data to the external apparatus after authentication of the external apparatus if it is determined that the data transmission has not been instructed; and
transmitting data to the external apparatus without authentication if it is determined that the data transmission has been instructed.
